(19) United States
(12) Patent Application Publication
(10) Pub. No.: US 2004/0128191 A1
(43) Pub. Date: Jul. 1, 2004

(54) Method and apparatus for improving performance of a wireless communication network

(76) Inventor: Michael Kotzin, Buffalo Grove, IL (US)

Correspondence Address: VEDDER PRICE KAUFMAN & KAMMHOLZ, 222 N. LASALLE STREET, CHICAGO, IL, 60601, US

(21) Appl. No.: 10/334,821

(22) Filed: Dec. 31, 2002

(51) Int. Cl. G06F 17/60

(52) U.S. Cl. 705/14

(57) ABSTRACT

A method and apparatus for improving performance of a wireless communication network (11) obtains air interface resource capability data (26), from a wireless device (12) or other source, and determines if the obtained air interface resource capability data (26) of the wireless device (12) warrants a reward by the wireless communication network (11). If the air interface resource capability data (26) of the wireless device (12) warrants a reward, the system operator, through a network element (16) or other suitable device provides a reward associated with the wireless device. This may include, for example, a financial reward, such as a reduction in cost for air time, billing credit or a performance improvement such as a reduction in frame error rate that is used when the wireless device (12) is in communication with the wireless communication network (11).

### FIELD OF THE INVENTION

The invention relates generally to wireless communication systems, and more particularly to methods and apparatus for improving wireless communication network performance.

### BACKGROUND OF THE INVENTION

Wireless communication networks, such as wireless code division multiple access (WCDMA), CDMA and other cellular wireless communications networks are known that deliver internet based content or other content and provide voice communication with one or more wireless devices. System operators of such wireless communication networks bill users of wireless devices that communicate using the wireless communication network. Advances in wireless device technology and infrastructure are requiring subscribers and network operators to invest larger sums of money in equipment. However, there is little motivation for a subscriber to purchase a wireless device that performs better than any other wireless device—particularly if the user experiences no difference from its use.

Generally speaking, better performing wireless devices can cost more than poorer performing devices. There would be a great benefit to a system operator and subscribers if subscribers would in someway be rewarded for purchasing the improved wireless devices, since the system operator can realize significant system performance improvements. For example, using an enhanced wireless device can increase system capacity so that the operator can accommodate more subscribers, which can allow the operator to obtain a significantly improved return on the investment in the infrastructure. Hence, it would be desirable to have a method and apparatus that improved the performance of wireless communication networks.

### BRIEF DESCRIPTION OF THE DRAWINGS

The present invention and the corresponding advantages and features provided thereby, will be best understood and appreciated upon review of the following detailed description of the invention, taken in conjunction with the following drawings, where like numerals represent like elements and, in which:

FIG. 1 is a block diagram illustrating one example of a wireless communication employing a network element in accordance of one embodiment of the invention;

FIG. 2 is a block diagram illustrating one example of a method for improving performance of a wireless communication network in accordance with one embodiment of the invention;

FIG. 3 is a flow chart illustrating one example of a method for improving performance of a wireless communication network in accordance with one embodiment of the invention; and

FIG. 4 is a portion of a flow chart representing steps of a method for improving performance of a wireless communication network in accordance with one embodiment of the invention.

### DETAILED DESCRIPTION OF THE PREFERRED EMBODIMENT

Briefly, a method and apparatus for improving performance of a wireless communication network obtains air interface resource capability data from a wireless device or other source, and determines if the obtained air interface resource capability data of the wireless device warrants a reward by the wireless communication network. If the air interface resource capability data of the wireless device warrants a reward, the system operator, through a network element or other suitable device provides a reward associated with the wireless device. This may include, for example, a financial reward, such as a reduction in cost for air time, billing credit or a performance improvement such as a reduction in frame error rate that is used when the wireless device is in communication with the wireless communication network. Hence a subscriber of a wireless device may pay more to buy a wireless device that provides for example, certain improved air resource capabilities, such as a receiver with downlink diversity capability, higher transmit power capability or other capability and the subscriber is subsequently rewarded for using the device since the device capability improves the wireless communication network's performance, by, for example, allowing additional wireless devices to operate, or other suitable system performance improvements. Hence, a subscriber to the wireless network is rewarded by the wireless communication network if they purchase for example, a more expensive wireless device or wireless devices that have capabilities that enhance wireless communication network performance.

The air interface resource capability data represents the relevant air interface resource capabilities of a device (including a device type) and may be stored locally by the wireless device and sent to the wireless communication network, or the air interface resource capability data may be stored by a database accessible by the wireless communication network, so that a billing system or other suitable system can access the information to determine whether a reward should be provided.

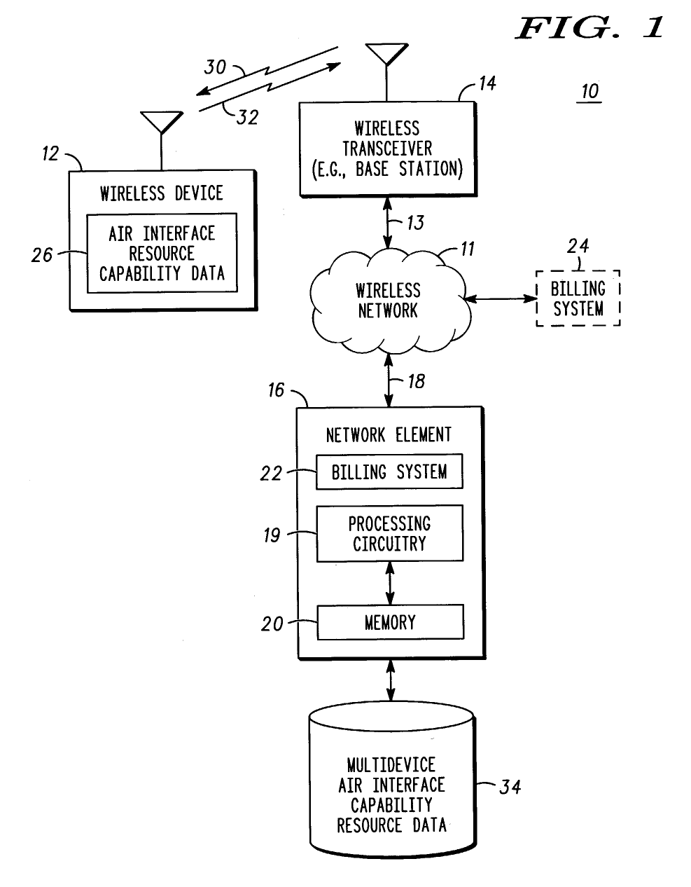

FIG. 1 illustrates one example of a wireless communication system 10 that communicates with one or more wireless devices 12 using one or more wireless transceivers 14, such as wireless base stations or other suitable communication devices. The wireless transceiver 14 is operatively coupled to or is part of a wireless communication network 11, which contains other network elements and access points to the internet, switching centers and other suitable networks as known in the art. The wireless communication system 10 also includes an apparatus, such as a network element 16 operatively coupled to other components in the wireless communication network through a suitable communication link 18, and may be for example a mobile switching center, a server or other suitable software or hardware element that is operatively coupled or is part of the wireless communication network 11. The network element 16 may be incorporated as part of a wireless transceiver 14, a base station controller, or any other suitable component of a wireless network or may be external to the wireless network, such as a web server or other element that is operatively coupled to the wireless communication network 11 through any suitable communication link. The wireless transceiver 14 is suitably coupled to the wireless network through a suitable link 13 as known in the art.

The network element 16 includes processing circuitry 19 and associated memory 20. The processing circuitry 19 may be for example, one or more computers, switches, digital signal processors (DSP's), microcontrollers, microprocessors, discrete logic circuits or any suitable combination of hardware, software or firmware. In one embodiment, the processing circuitry 19 includes a microprocessor that executes executable instructions stored in the memory 20 to carry out the operations as described herein. As such, memory 20 which may be a ROM, RAM or any suitable storage medium for storing digital data, contains executable instructions that when executed by one or more processing devices causes the one or more processing devices to operate as described herein. The processing circuitry 19 provides a suitable interface so that a system operator can suitably select the operations as desired and further described herein. The network element 16 is also shown to include a billing system 22 in the form of one or more suitable software applications executed by the processing circuitry 19 or other suitable processor. The billing system 22 may be, as shown by dash lines 24, located in another network element or any other suitable location and may be accessible, for example, via an internet connection and may be available through a web server or other suitable network element. The billing system 22 records reward events and other information to facilitate the issuance of billing data for use of the wireless communication network by the one or more wireless devices 12.

In a preferred embodiment, although not required, the wireless device 12 includes air interface resource capability data 26 stored locally in the wireless device memory in the form of, for example an equipment identifier (El) which represents for example that the wireless device has a diversity receiver. Since a diversity receiver may more effectively receive and detect lower power signals sent from the wireless communication network 11 and signals in the presence of a higher level of other-user-generated noise, the use of this air interface resource capability is rewarded so that the subscriber or user of the wireless device receives a benefit for using a wireless device that enhances system performance. The network element 16 may obtain the air interface resource capability 26 through any number of different mechanisms. In one embodiment, the network element 16 obtains the air interface resource capability data 26 that is associated with the wireless device 12 by sending a query 30 to the wireless device 12 asking for wireless device's air interface resource capabilities. In response to the query 30, sent for example, by the wireless communication network 11 as initiated by the network element 16, the wireless device 12 sends air interface resource capability data 26 via a response 32 to the network element 16. As such, this is one mechanism for obtaining air interface resource capability associated with the wireless device 12.

In an alternative embodiment, the wireless device 12 may simply push the air interface resource capability data 26 to the network element 16 upon, for example, initially logging onto the wireless communication network 11. As another alternative, the network element 16 may include, or may be operably coupled with, a multi-device air interface capability resource data store 34, such as a suitable database, that stores the air interface capability resource data 26 for a plurality of wireless devices and may be populated when a wireless device 12 is initially given access to the wireless communication network 11 as either sent by the wireless device 12 or as provided through another mechanism through the network element 16 or other suitable source that populates the multi-device air interface capability resource data store 34.

Once the network element 16 has obtained the air interface resource capability data for a wireless device, it determines if the obtained air interface resource capability data warrants a reward. For example, if the air interface resource capability data 26 indicates that the wireless device is capable of providing downlink diversity reception, the wireless device can improve the capacity of the system and hence, the network element 16 determines that it is a type of resource capability that deserves a reward. This may be done, for example, by comparing the obtained air interface resource capability data 26 with locally stored reward criteria data that indicates whether the wireless device has air interface resource capabilities that would improve performance of the wireless communication network. The reward criteria data may simply be a list of device capabilities that if detected in a wireless device are selected as warranting a reward, and hence the network element 16 initiates the appropriate action to provide a suitable reward as described below. The air interface resource capability data 26 may be any suitable data such as simply a device identifier since the network element 16 may have a list of devices that have improved capabilities for which the system operator wants to encourage use.

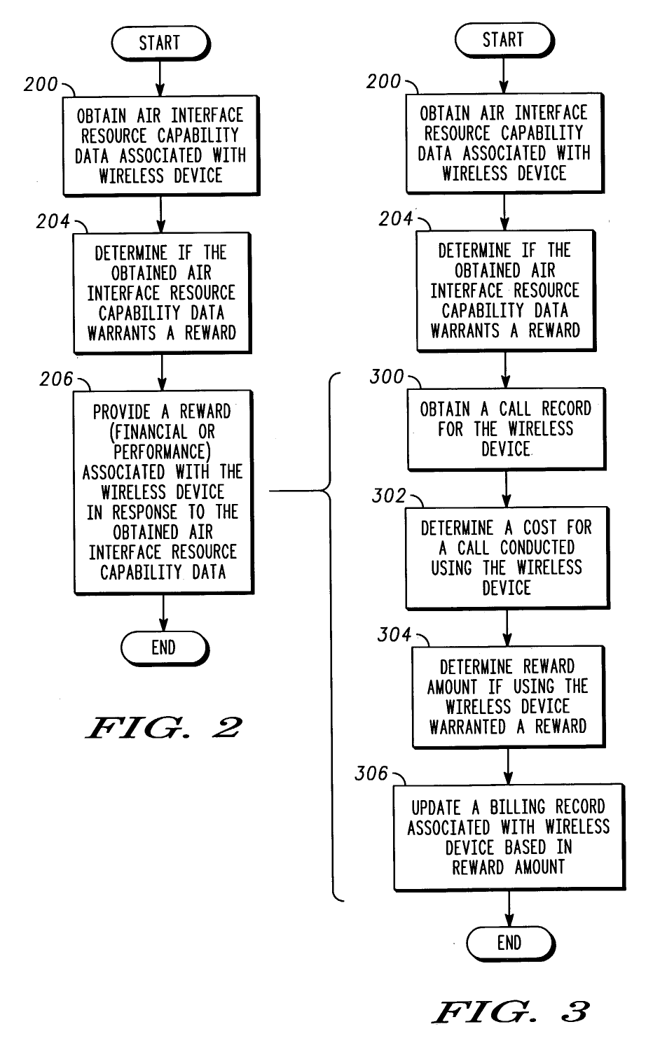

FIG. 2 is a flow chart illustrating one example of a method for improving performance of a wireless communication network that may be carried out, for example, by the network element 16 or other suitable combination of devices or processes. As shown in block 200, the method includes obtaining the air interface resource capability data 26 associated with the wireless device 12 from a suitable source, such as from the device itself or from a database such as the multi-device interface capability resource data store 34. As shown in block 204, once the air interface resource capability data 26 is obtained, the method includes determining if the obtained air interface resource capability data 26 warrants a reward. As shown in block 206, the method includes providing a reward such as a financial reward or a performance award, for the wireless device in response to the obtained air interface resource capability data.

Obtaining the air interface resource capability of a wireless device as noted above, may include receiving the air interface resource capability data 26 while the wireless device 12 is in communication with the wireless communication network 11 based on initiation by the wireless device 12, such as if the wireless device 12 pushed the information to the network element 16. Alternatively, the air interface resource capability data 26 may be obtained in response to the query 30 sent by the wireless communication network 11 or by accessing a database such as a multi-device air interface capability resource store 34, and any other suitable data, in any suitable manner.

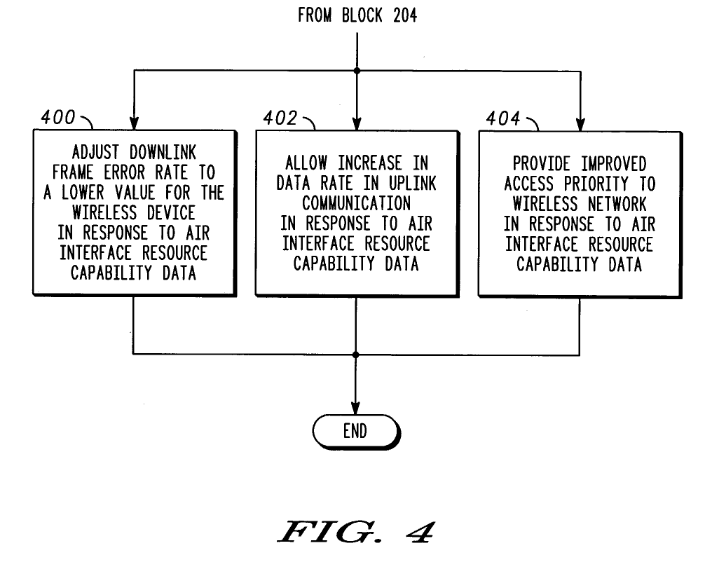

FIG. 3 is a flow chart illustrating another method for improving performance of the wireless communication network 11 in an embodiment where the wireless communication network 11 is a cellular wireless communication network and where the wireless device 12 includes a cellular telephone module capable of placing calls using the wireless communication network 11. As shown in block 300, the method includes obtaining a call record for the wireless device for a particular call that has been placed. These steps may be carried out for example, by the processor circuitry 19. As shown in block 302, the method includes determining a cost for the call conducted using the wireless device, as known in the art. As shown in block 304, the method includes determining a reward amount if the wireless device being used warrants a reward, as determined for example, in block 204. The reward as noted above may be a financial reward so that data is generated to update a billing record that is associated with the wireless device such as a reduction in fee amount in a billing record database associated with the billing system. Alternatively, the reward may be a performance reward such that instead of generating data to update a billing record or giving the subscriber a discount of their bill and generating a billing statement based on the reward, the network element notifies the wireless communication network 11 to provide improved performance for the device. As one example, this may include adjusting the downlink frame error rate to a lower value for the device so that the audio received by the wireless device sounds better. Alternatively, the data rate in a forward direction can be allowed to be increased so that a wireless device may send more information to the network. Alternatively, the wireless device can be provided more favorable scheduling times so that the subscriber gets better service. Any other suitable performance rewards may also be used based on the air resource capability data. Hence, the financial rewards may include generating data to update a billing record to include at least one of a discount on air time used and an increase in air time allowed, or any other suitable financial reward. The financial reward is stored as data as part of the billing system so that a subscriber is notified of the billing event by e-mail or other suitable mechanism.

Performance rewards include, for example, adjusting a downlink frame error rate to a lower value for the wireless device, allowing an increase in the data rate in an uplink communication, providing improved access priority to the wireless communication device, or other suitable performance reward. As such, as shown in block 306, the method includes updating a billing record associated with the wireless device based on a reward amount if a financial reward is given. This may be done by the billing system 22.

Examples of air interface resource capability data includes data representing for example, whether the wireless device has diversity reception capability, whether the wireless device has higher transmission power capability than other wireless devices, has enhanced receiver signal processing capabilities, such as single antenna interference cancellation processing capability, has additional frequency band access capabilities so that a user may pay for an additional band, such as one or more additional downlink frequency bands so base station can modify its air resource allocation accordingly by actively changes its mode of communication or any other suitable air interface resource related capability that can enhance system performance.

FIG. 4 is a portion of a flow chart illustrating alternative performance rewards provided by the wireless communication network 11 as notified by the network element 16. As noted above, the method may include in response to determining that the wireless device deserves a reward since it has suitable air interface resource capabilities, as shown in block 400, adjusting a downlink frame error rate for the wireless device to a lower value, as shown in block 402 or alternatively allowing an increase in data rate in the uplink communication in response to the air interface resource capability data, or alternatively or in addition to, providing improved access priority to the wireless network in response to the air interface resource capability data.

The above methods and apparatus may help induce a subscriber to pay more for a wireless device that provides additional network performance enhancements, while also allowing a system operator to increase revenue since the system is being used more efficiently thereby allowing, for example, more users to use the system since the system capacity is improved, or attract additional subscribers since the quality of communication is improved. Other benefits may also be realized.

The above detailed description of the invention and the examples described therein have been presented for the purposes of illustration and description. It is therefore contemplated that the present invention cover any and all modifications, variations or equivalents that fall within the spirit and scope of the basic underlying principles disclosed above and claimed herein.

What is claimed is:

1. A method for improving performance of a wireless communication network comprising:
obtaining air interface resource capability data associated with a wireless device that is capable of communicating with the wireless communication network;
determining if the obtained air interface resource capability data of the wireless device warrants a reward; and
providing a reward associated with the wireless device, in response to the obtained air interface resource capability data.

2. The method of claim 1 wherein the step of obtaining the air interface resource capability data associated with the wireless device includes at least one of: receiving the air interface resource capability data while the wireless device is in communication with the wireless communication network based on initiation by the wireless device; receiving the air interface resource capability data in response to a query sent by the wireless communication network; accessing, by the wireless communication network, a database containing stored air interface resource capability data associated with the wireless device.

3. The method of claim 2 wherein the step of providing a reward associated with the wireless device includes at least one of: providing a financial reward associated with the wireless device and providing a wireless device performance reward.

4. The method of claim 1 wherein the step of determining if the obtained air interface resource capability data warrants a reward includes comparing the obtained air interface resource capability data with reward criteria data indicating whether the wireless device has air interface resource capabilities that would improve performance of the wireless communication network.

5. The method of claim 1 wherein the air interface resource capability data includes data representing at least whether the wireless device:
has diversity reception capability;
has higher transmission power capability than other wireless devices;
has enhanced receiver signal processing capabilities;
has additional frequency band access capabilities; and
has additional modulation mode capabilities.

6. The method of claim 3 wherein providing the financial reward includes updating a billing record associated with the wireless device to indicate at least one of:
a discount on air time used; and
an increase in air time allowed,
and wherein providing the wireless device with a performance reward includes at least one of:
adjusting a downlink frame error rate to a lower value for the wireless device,
allowing an increase in a data rate in an uplink communication;
providing improved access priority to the wireless communication network.

7. The method of claim 1 including:
obtaining a call record for the wireless device;
determining a cost for a call conducted using the wireless device;
determining a reward amount if using the wireless device warranted a reward; and
updating a billing record associated with the wireless device based on the reward amount.

8. An apparatus operatively couplable to a wireless communication network comprising:
processing circuitry operative to:
obtain air interface resource capability data associated with a wireless device that is capable of communicating with the wireless communication network;
determine if the obtained air interface resource capability data of the wireless device warrants a reward; and
provide a reward associated with the wireless device, in response to the obtained air interface resource capability data.

9. The apparatus of claim 8 wherein the processing circuitry obtains the air interface resource capability data associated with the wireless device by at least one of:
receiving the air interface resource capability data while the wireless device is in communication with the wireless communication network based on initiation by the wireless device;
receiving the air interface resource capability data in response to a query sent by the wireless communication network; and
accessing, by the wireless communication network, a database containing stored air interface resource capability data associated with the wireless device.

10. The apparatus of claim 9 wherein processing circuitry provides the reward associated with the wireless device by at least one of: providing a financial reward associated with the wireless device and providing a wireless device performance reward.

11. The apparatus of claim 9 wherein the processing circuitry determines if the obtained air interface resource capability data warrants the reward by comparing the obtained air interface resource capability data with reward criteria data indicating whether the wireless device has air interface resource capabilities that would improve performance of the wireless communication network.

12. The apparatus of claim 9 wherein the air interface resource capability data includes data representing at least whether the wireless device:
has diversity reception capability; and
has higher transmission power capability that other wireless devices.

13. The apparatus of claim 11 wherein the processing circuitry provides the financial reward by updating a billing record associated with the wireless device to indicate at least one of:
a discount on air time used; and
an increase in air time allowed,
and wherein providing the wireless device with a performance reward includes at least one of:
adjusting a downlink frame error rate to a lower value for the wireless device,
allowing an increase in a data rate in an uplink communication;
providing improved access priority to the wireless communication network.

14. The apparatus of claim 9 wherein the processing circuitry:
obtains a call record for the wireless device;
determines a cost for a call conducted using the wireless device;
determines a reward amount if using the wireless device warranted a reward; and
updates a billing record associated with the wireless device based on the reward amount.

15. The apparatus of claim 9 including a database operatively coupled to the processing circuitry containing air interface resource capability data for a plurality of wireless devices.
